(19) United States
(12) Patent Application Publication
(10) Pub. No.: US 2024/0265389 A1
(43) Pub. Date: Aug. 8, 2024

(54) CRYPTOGRAPHIC PROTOCOL INCLUDING PAIRED CRYPTOGRAPHIC EVENTS ASSOCIATED WITH A BLOCKCHAIN

(71) Applicant: DMG Blockchain Solutions Inc., Delta (CA)

(72) Inventors: Adrian Glover, Surrey (CA); Steven Eliscu, San Mateo, CA (US); Sheldon Bennett, Surrey (CA); Wei Jang, Calgary (CA)

(21) Appl. No.: 18/395,141

(22) Filed: Dec. 22, 2023

Related U.S. Application Data
(60) Provisional application No. 63/477,164, filed on Dec. 23, 2022.

(51) Int. Cl. G06Q 20/38

(52) U.S. Cl. CPC G06Q 20/389

(57) ABSTRACT

Systems and methods for processing events transmitted by an application to hashing processors executing a custom paired event generation protocol that is independent of the vanilla blockchain protocols. Events are transmitted including additional scripts that cause nodes including the custom protocol to generate a paired event. the paired event enables creators of the initial event to have some agency in whom benefits from mining the initial event to blocks on the blockchain. The blocks are appended to the blockchain according to the vanilla blockchain protocol. Thus, users exercise intentionality over which hashing processors process their events and which other events will be hashed into a block with the users' events.

### TECHNICAL FIELD

The disclosure relates to operation of a pool of hashing processors and more particularly to structural requirements of forming blocks in a blockchain data structure.

### BACKGROUND

Some blockchains systems record movement of cryptographic objects between cryptographic identifiers and operate on distributed consensus networks. A blockchain is an immutable, append-only public ledger. A benefit of such a data structure is that it is reliable, secure, and open. Within the distributed consensus networks, there tend to be congregations of processing power referred to as pools. The pools use ASIC processors designed for hashing to more efficiently generate the block data structures from available events. Cryptographic events typically include user assigned processing fees that transfer during processing blocks. These fees are claimed by whichever miner processes the event. Higher fees lead to greater priority for miners. Additionally, cryptographic protocols tend to remove zero-fee transactions from the mempools of miners so as to not propagate the zero-fee transaction from mempool to mempool.

### BRIEF DESCRIPTION OF THE DRAWINGS

FIG. 1 is a block diagram of a blockchain data structure.

FIG. 2 is an illustration of a mempool.

FIG. 3 is a flowchart illustrating generation of paired events.

FIG. 4 is a flowchart illustrating propagation of paired cryptographic events across multiple mempools.

FIG. 5 is a diagrammatic representation of a system with a collective mempool for processing events transmitted by an application.

FIG. 6 is a block diagram of an exemplary computing system.

### DETAILED DESCRIPTION

In block creation, a miner generally requests a “block template” from a full node on a distributed consensus network. This block template will have a list of events that exist in the mempool. The mempool is where all valid events wait to be confirmed by the entire distributed consensus network. Described herein, is a cryptographic event creation protocol that operates on participating nodes/mempools. The protocol is opt-in and does not directly conflict with a base-standard protocol of a given blockchain (e.g., the Bitcoin protocol as associated with the Bitcoin blockchain). In this manner, the custom event creation protocol is compatible with existing consensus protocols that stakeholders of a given blockchain protocol have not voted on. The custom protocol disclosed herein enables a paired event node that creates a paired cryptographic event for received cryptographic event.

The paired event node applies the custom protocol to a given node on a public blockchain (e.g., Bitcoin, Ethereum, etc. . . . ). When an initial cryptographic event is submitted to a mempool, one or more additional events are automatically created that are paired with the initial cryptographic event. The paired events include a bounty. When processed, the paired events include the following condition: has a predetermined miner associated with the subject paired event processed the initial event either in an earlier block, or the block the paired event is processed in. If the condition is met, the paired transaction pays out to the predetermined miner or pool.

Once generated, the paired event need not be generated again. The mempool keeps the paired event and flushes out the events that have been included in the most recent block added to the chain. In some embodiments, there remains only a single paired event (e.g., that implements P2SH type 1 to N to reference each eligible miner). In other embodiments, multiple paired events exist corresponding to each eligible miner.

In some embodiments, the initial event is a zero-fee or inconsequential-fee cryptographic event. In this way miners who are not associated with a paired event are heavily disincentivized from processing the initial event. Over time, the disincentive becomes stronger as less cryptocurrency is awarded with each processed block and incentive for processing blocks is more closely tied to processing fees of each transaction. In effect, a user generating the initial event can pick and choose their miners based on whatever selection criteria is important to them. In one example, paired transactions are generated for miners or pools who have demonstrated that their hashing processors operate using green energy sources. Dirty energy sources are therefore disincentivized.

### Terminology

An entity is any person or company, or merely a reference to either, that owns the private keys to a public address (cryptographic identifier). Examples are: Mrs. Jones, Binance Exchange, 2016 Bitfinex Thief.

The Bitcoin mempool (short for memory pool) is a collection of all Bitcoin transactions (“event”) awaiting verifications and confirmation which will be included in the next block. Whenever a Bitcoin event is channeled to the network, it first gets verified by all the Bitcoin nodes available, which takes an average of 10 minutes to get its first verification. Processing blocks can take longer than 10 minutes, depending on the pending events that are in the mempool. Mempool is the node's maintaining and restraining area that focuses on transactions awaiting approval. When one transaction gets verified and included, the next one is in line to get added. Cryptocurrencies other than Bitcoin operate using mempools as well. Bitcoin is referenced here as an example.

The collection of these transactions is called a “block” and whichever miner first solves the math problem gets to add this block to Bitcoin's blockchain. However, if the size of the Bitcoin mempool is high, transaction fees recommended by exchanges go up to improve the rate. A given user is enabled to choose how expensive they wish to transaction fee to be. If one sets the fee higher than average, chances are that transaction will be confirmed quicker. Failing to attach high fees could result in a transaction being delayed for many days if the memory pool does not clear.

An Exchange is an entity that operates a plurality of addresses. Even though a customer of an exchange is given a deposit address, the address is truly owned by the exchange rather than by the customer, since the exchange controls the private keys to that address.

Each entity belongs to one of a definitive set of categories. Some illustrative examples include: exchange, gambling site, dark market, scammer or mixer. A category may be assigned a degree of criminality that in some embodiments, affect an initial AddressScore. For instance, the dark market category receives a high initial score (e.g., near or above a criminality threshold), whereas a law enforcement agency a and private individuals have an inherent score of 0. An entity belonging to a category that has a higher initial score carries some intrinsic risk. Otherwise, it derives extrinsic risk from nearby entities having intrinsic risk.

A wallet is the set of addresses (or cryptographic identifiers) belonging to a single entity (or set of entities, to accommodate multisig addresses). In some instances, an entity has multiple wallets, as in the case of an exchange that stores some value in “cold” storage wallets, and some in “hot” storage. In a similar fashion to entities, wallets have either intrinsic or extrinsic risk.

Although one can partition addresses into wallets, there is difficulty identifying the entities that own them. However, the system can sometimes identify at least the category of the (unknown) entity that owns the wallet. Clues about the wallet's category often come from topological properties about its transactions. For example, to the extent that a given transaction exemplifies mixing, the system can then further infer that the input and output addresses belong to a mixer.

A wallet's transactional neighborhood is the set of wallets that have transacted with the given wallet, plus those that have transacted with that wallet's transactors, and so on. While there is no strict limit to the number of hops that constitute the neighborhood, an intuitively definition is “less than the entire network of wallets, and more than just a single wallet.”

A custom blockchain protocol refers use of a protocol that is modified, but remains compatible with an existing, vanilla protocol. The custom protocol is independent of and compatible with the public blockchain protocol. The custom protocol affects how a given node (or set of nodes) behaves and interacts with the greater distributed consensus network; however, the custom protocol does not interfere with the ability of the given node to interact with the vanilla blockchain protocol. A vanilla protocol refers to protocols voted on by stakeholders of the protocol. As used herein, nodes and hashing processors are also known as miners.

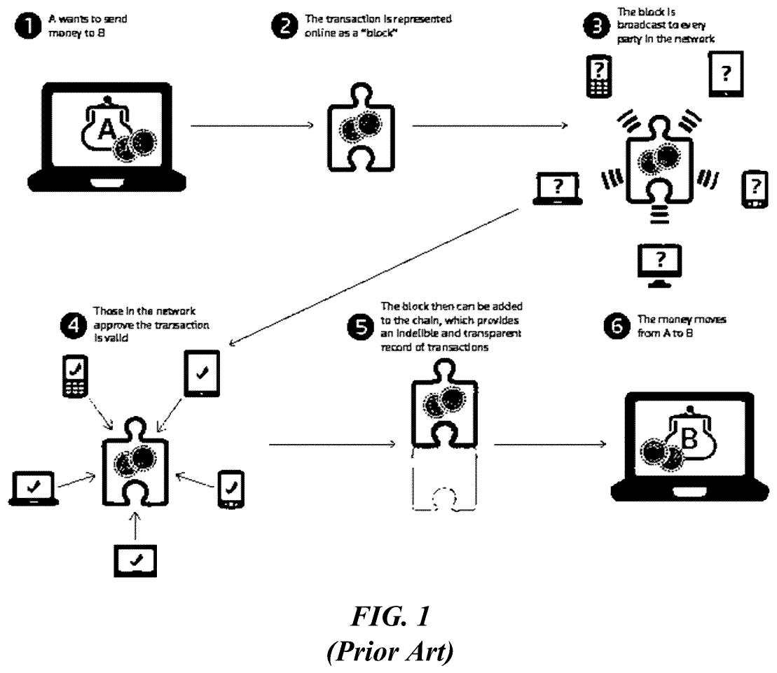

FIG. 1 is a block diagram of a blockchain data structure. Cryptocurrency networks operate on a distributed network architecture. Key to understanding cryptocurrency is the data structure upon which the network operates. For example, the Bitcoin and Ethereum networks use a data structure referred to as a blockchain.

The blockchain includes a history of all transactions that have ever occurred on the network. Each full node in the distributed network holds a full copy of the blockchain. To participate in the network at all, the blockchain history must be consistent with the history of at least a majority of other nodes. This consistency rule has an important effect of causing the blockchain to be immutable. In order to effectively attack a blockchain, one must control 51%+ of the processing power of the entire network. Where the network is comprised of thousands of nodes, assembling the requisite 51% is exceedingly difficult. Further, modifications of the vanilla protocol require 51% of stakeholders to vote in favor of those modifications. Where stakeholders cannot agree, the blockchain forks into different versions.

Many nodes tend to group together to form pools. Often these pools operate large warehouses of ASIC hashing processors, specifically designed to efficiently solve math problems that generate hash values. While it is true that many nodes often group together in pools that together work together to solve for nounces to propagate the blockchain, the grouped nodes of the pool do not necessarily share common control. While they have agreed to pay any mined coins to a central pot that is shared amongst the pool, this is far and away from agreeing to make changes to the blockchain.

When a given node intends to generate a transaction, the transaction is propagated throughout the nodes, via the mempool, until it reaches a node or group of nodes that can assemble that transaction and other transactions generated during a contemporaneous period of time into a block. Until a transaction appears in a block it is not published or public. Often a transaction isn't considered confirmed until 6 additional blocks have been added.

At the time of this filing, Bitcoin blocks are limited to the size of 1 MB and are generated approximately every 10 to 15 minutes. This illustrates an important limitation of the Bitcoin network, that it only processes approximately 7 transactions per second. Conversely, Ethereum limits block size based on the amount of processing the contracts in the given block call for and are appended every 5 to 15 seconds. While cryptocurrency networks technically begin processing transactions in real-time, and the existence of a block including a given transaction verifies that transaction's authenticity, until that block is published to the blockchain, the transaction is not verified.

Thus far, Bitcoin has been discussed as a network for trading Bitcoins. However, Bitcoin transactions have additional utility in that they can embed additional data. As contemplated above, Bitcoin can be used to purchase and record the existence of data at a given point in time. Recording data is performed by including hashed data within an output field of a given transaction. In this manner, the proof of existence for any document or recorded data may be embedded into the immutable history of the blockchain.

Systems that utilize the Bitcoin blockchain to transfer the ownership of non-coin assets require software that is separate from and merely relies upon the immutability of the blockchain. The separate software is not necessarily secure or immutable itself. Extra-blockchain software is thus an inherent weak point in a system that relies upon the immutability of the blockchain to ensure security. Ethereum takes the ability to buy and sell non-coin assets a step further.

Ethereum smart contracts are in effect software that runs on the blockchain. That software is open source and subject to inputs that are related to the blockchain itself. Of course, one can still write code including vulnerabilities, but the platform enables greater security and fewer weak links in the chain.

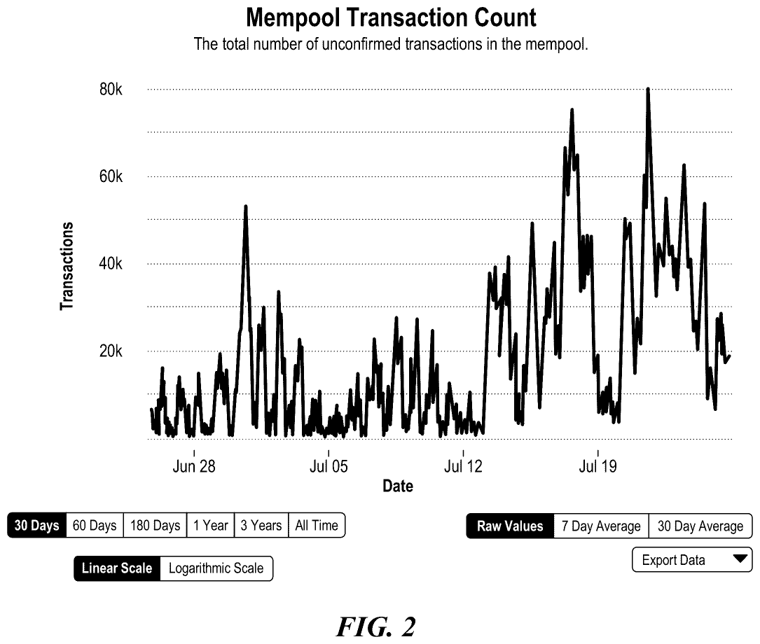

FIG. 2 is an illustration of the Bitcoin mempool over time. The Bitcoin mempool is portrayed here as an example. Other cryptographic objects make use of similar mempools. The mempool is where all valid transactions wait to be confirmed by the cryptographic object network. A high number of transactions in the mempool indicates a congested traffic which will result in longer average confirmation time and higher priority fees. The mempool count metric tells how many transactions are causing the congestion whereas the mempool Size (Bytes) chart is a better metric to estimate how long the congestion will last.

In order to be confirmed, a transaction from the mempool needs to be included in a block. Unlike the maximum size of a block which is fixed, the maximum number of transactions which can be included in a block varies, because not all transactions have the same size.

Each Bitcoin node builds its own version of the mempool by connecting to the Bitcoin network. The illustrated mempool content is aggregated from a few instances of up to date Bitcoin nodes maintained by the Blockchain.com engineering team. However, in a disclosed paired event node the mempool may look different based on the treatment of high AddressScore transactions/events.

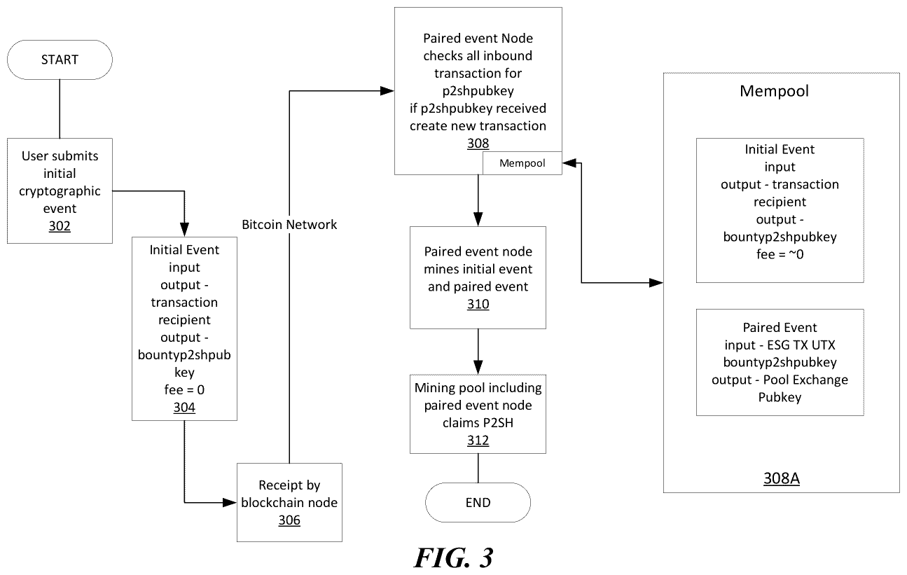

FIG. 3 is a block diagram-flowchart illustrating generation of paired events. In steps 302 and 304, an initial user submits an initial event to a blockchain node. That initial event includes as outputs an intended transaction recipient and one or more P2SH functions associated with a paired (“bounty”) transaction. The P2SH public key is exchanged between the initial event creator and those miners who are on an allow list to process paired events. The key exchange technique applies any of a number of different options. Examples include secure key exchange techniques (e.g., Diffie-Hellman, public-key infrastructure, password authenticated key agreements, etc.), applications separate from the blockchain architecture (e.g., API plugins, public publication on websites, etc.).

In some embodiments, each designated mining pool operator that meets the desired criteria to be bounty collectors provide a public key to the administrator. The administrator generates a P2SH function of type 1 of N using all of the provided public keys and provides said P2SH pub key address and redeem script to all designated mining pool operators. The designated fee for processing the initial event is set to zero, or an otherwise inconsequential amount (e.g., a minimal amount of Satoshis if processed on the Bitcoin blockchain). The exceedingly low transaction fee serves to dissuade unintended miners from processing the initial event.

Users who wish to pay transaction fees through the bounty system will designate a low or zero transaction fee and broadcast their transaction with an output to the P2SH pub key for the bounty.

In step 306, the initial event is received by a blockchain node. This node may either be a vanilla node, a paired event node, or some other type of custom node. Given the predominance of vanilla nodes, receipt by vanilla nodes is most likely in circumstances where intentional node delivery is not implemented.

At the time of writing, vanilla Bitcoin nodes will not propagate zero-fee events across the greater mempool of the blockchain network. To overcome the mempool propagation issue on vanilla Bitcoin nodes, a minimal fee is used instead. The minimal fee is a low amount of Satoshis that the vanilla Bitcoin protocol will allow mempool propagation. A similar approach is applied to similarly situated blockchain protocols.

Conversely, in embodiments that operate only on paired event nodes (or other custom node protocol), the disclosed method is free to use zero-fee events as the paired event nodes are configurable to propagate such events to the mempool of other paired event nodes based on allow lists.

In step 308, the initial event eventually arrives in the mempool of a paired event node. As stated above, a paired event node is potentially the first node in receipt of the initial event. In such circumstances, step 306 is skipped.

The paired event node is configured to inspect all inbound events for relevant P2SH public keys. Upon identifying a P2SH pub key associated with a paired event (e.g., from the initial event), the paired event node generates a paired event. The paired event to the initial event is inserted into the mempool of the paired event node. 308A of FIG. 3 depicts events in the mempool of the paired event node.

In some embodiments, the paired event is generated by the user who generates the initial event. Where the initial user generates both events, the initial event and the paired event propagate across the greater mempool together. Thus, the generation of the paired event by the paired event node is only necessary where the initial event propagates but the paired event is not received.

In step 310, the paired event node attempts to process/mine the initial event along with the paired event. The paired event node may not be the first paired event node to attempt such processing. Mining pool operators who wish to collect the bounty from the paired event include both the initial event from step 304 and the paired event that they generate in the same block template. The bounty is distributed to the miners so that when the transaction is mined, so is the bounty collection. Routing of the bounty within a pool (e.g., to pool managers and hash processors) is subject to whatever preexisting arrangement exists for that pool.

In step 312, the mining pool that that mined the initial event (and presumably the paired event) claims the P2SH amount (“the bounty”). The bounty is claimed in a number of ways based on embodiment implementation. For example, a P2SH defined as a 1 of N so that all potential collectors of the bounty can spend the one unspent transaction output (UTXO). Where the P2SH refers to a single mining pool, that single miner is enabled to claim the UTXO. Claiming verifies the condition that the predetermined miner associated with the subject paired event processed the initial event either in an earlier block, or the block the paired event is mined in.

Only the mining pools that have been vetted and made part of the P2SH 1 of N, are able to claim. In some circumstances when the mempool has been low, and as a result, a mining pool that is not part of the P2SH has mined the event. Where an unvetted miner processes the initial event and the bounty is on the chain as a UTXO on the P2SH, then the creator of the initial event is enabled to claim the bounty back. An example means to enable a refund of the bounty involves including the originator's public key as one of the 1 to N addresses of the P2SH function.

Only the participant of the P2SH that mined the initial event may claim the bounty, with the exception of the initial user, who may reclaim the bounty where no participant of the P2SH mined the initial event. Some embodiments preclude the possibility of mining the initial event without the bounty spend by blocking inclusion of the initial event in a block until the paired event is appended.

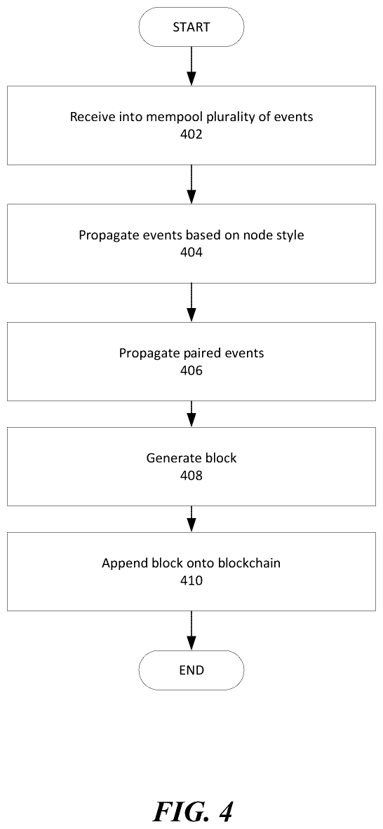

FIG. 4 is a flowchart illustrating propagation of paired cryptographic events across multiple mempools. Based on implementation, the need to propagate the paired event varies. Where each paired event node produces a corresponding paired event for itself, it is not necessary to propagate the paired event into other mempools. However, in some circumstances, propagation of the paired event cures edge case issues. In step 402, the mempool for the distributed consensus network receives a plurality of events. Some such events. The mempool is made up of a number of nodes. The mempool for each node may differ. A group of nodes may assemble together into a mining pool, that works together. The nodes of a pool are operated by ASIC hashing processors specifically designed to compute hash values efficiently.

Each of the events include a cryptographic identifier associated with an input and/or and output of the transaction. Some transaction events include additional cryptographic identifiers. The cryptographic identifiers are often referred to as “public keys.” The transaction events are collected together (based on memory size) and used to form blocks in a blockchain. The initial transaction events carry a transaction fee of zero, or an otherwise inconsequential amount.

In step 404, the nodes follow vanilla blockchain protocol and forward/propagate received events to other nodes within the network. However, vanilla nodes are typically configured to drop zero fee transactions as spam. These will not be propagated unless the particular node's protocol includes opt-in protocol that causes the subject node to forward the zero-fee transactions. In some embodiments, the opt-in protocol modification includes the condition that the zero-fee transactions include a P2SH output. The opt-in protocol need not be a full-paired event node, but simply a mempool forwarding protocol modification. Where an inconsequential fee transaction is used, vanilla protocols that drop events with zero-transaction fees do not hinder propagation. Discarding the transactions alters the mempool with respect to a mempool that other nodes that are not part of the pool would otherwise see.

In step 406, the paired events are propagated by mining pool cluster. The paired event of a single node that is a member of a given mining pool propagates the paired event to the others in the pool for block template generation. Where the pair of events stays just within a given mining pool's mempool, that mining pool attempts to solve a block template with the event pair included so that the bounty is paid to that mining pool. If another mining pool wins a block without the initial event, the first mining pool rebuilds the block template and includes the event pair again, until another transaction shows up on the blockchain that spends the UTXO going to the bounty.

In step 408, the paired event node generates the block using the initial event and paired event. In step 410, the newly generated block is appended to the blockchain.

Some embodiments disclosed herein involve introducing an initial event (an “event”) to a blockchain ledger without first broadcasting the event to all nodes on the greater blockchain network via transmission to a select set of nodes/miners/hashing processors. Targeting a given set of miners creates another way in which an originator of an event (a user) requests that events be added to a mempool that is stored on a node. The result of targeting a specific set of miners for dissemination of an event is that a given user achieves some intentionality or agency into which events appear in the same blocks on the blockchain as with their events. Some embodiments involve an application interfacing with a custom node executing a custom mempool protocol.

A customized node for the blockchain stores a mempool of a set of hashing processing executing a custom mempool protocol. The custom node receives events through an application program interface (API) developed for insertion of otherwise off-chain events. The custom node mines an event based on the cryptographic hash included with the event. However, under the custom mempool protocol, the custom node will refrain from broadcasting or propagating any events that are received through the API to mempools of nodes that are not executing the custom mempool protocol. Thus, events that are submitted via the application to the custom node are known to the custom node and the custom node's like programmed nodes alone, and not to the rest of the greater blockchain network until such events are appended in blocks to the blockchain. The mining pool network (pool of hashing processors) associated with the custom node receives events that are submitted through the API into a collective mempool of that subset of miners i.e., the list of events that are waiting to be mined. Thus, only miners that are part of the mining pool associated with the custom node confirm events submitted through the API.

Users submit events through a custom application. In some embodiments, the application is a custodial wallet that enables users to submit their events to a blockchain through a web user interface. Events are digitally signed by a cryptographic private key of the user (e.g., using a hardware private key device that connects through the web user interface, custodial private key database, direct input etc.) according to the public blockchain protocol. The user submitted events are then submitted through the API to the custom node that processes the event according to the custom mempool protocol.

Some embodiments enable the custom node to process events received from the greater blockchain network. The custom node communicates information to and from neighboring nodes, some of which may not be executing the custom mempool protocol. When the custom node receives events from other nodes that are not executing the custom mempool protocol, the custom node performs a filtering process on these events. In some embodiments, the custom node specifically propagates events with parameters satisfying a screening criterion to be further processed by the custom node and other like-programmed nodes. In some cases, the screening criterion seeks events that are associated with paired, bounty events. Thus, events transmitted through the application will only be mined by nodes that are on a particular allow list based on whatever criteria that the user generating the initial event specifies (e.g., mine using green energy).

When a block is submitted to the blockchain network, verification of off-chain events via the custom node still operate in a manner that is compatible with the vanilla blockchain protocol. For example, the public address of a user's event is generated by hashing the event using the public key of the user. Blocks produced via the miners of the custom node are hashed in the same way as other blocks on the blockchain (e.g., the block are of the same maximum size, and reference the last hash of the previous block of an existing chain). Thus, while the custom node executes a custom mempool protocol for processing events, the custom node still adds events transmitted by the application to the blockchain consistent with the existing vanilla blockchain protocol.

A vanilla blockchain protocol refers to a set of protocols and network requirements that are controlled by influential developer groups and “voted” on by miners at large. For example, anyone can make changes to Bitcoin's code—it is open source. Getting the changes implemented, however, requires network consensus, and that is extremely difficult to achieve. Imagine trying to get 20 people with different philosophies, political convictions, economic incentives and life goals to agree on a simple change. Now, multiply that by hundreds if not thousands, and making the changes becomes even more complicated. The voting procedure protects the network from any change other than those the majority believe are beneficial to the entire ecosystem.

Some changes can be made to the protocol without the consent of the majority at large. These changes do not directly impact the way the resulting blocks appear to the greater network. These changes are thus, inherently, more restrictive. A reasonable analogy is application of the supremacy clause of the U.S. constitution as applies to federal and state law. Federal law sets minimum requirements, but states can set laws that are more restrictive. Where there is conflict, federal law controls. Similarly, a public blockchain protocol dictates how blocks are generated, but a custom protocol may add additional restrictions and remain compatible with the public blockchain protocol.

Thus, the custom node exerts greater control over the blocks it generates , or the events it propagates to other mempools than is otherwise required by the public protocol without requiring a hard fork of the blockchain. The custom node is therefore operating a different (more restrictive) protocol than many other nodes operating on the same consensus network (e.g., Bitcoin, Bitcoin Cash, Ethereum, Ethereum Classic, Litecoin, Ripple, Dogecoin, etc.).

Some embodiments disclosed herein allow the user more say over which mining pool or subset of the mining pool is able to process and confirm their event. Instead of being processed by unknown nodes throughout the greater blockchain network, events transmitted through the application are processed by the custom node executing the custom mempool protocol before being added to the blockchain. There is more information available about the miners associated with the custom node. In some cases, the information includes the miners' location of operation.

In some embodiments, miners have been vetted through a screening process that removes any undesirable miners. Thus, by submitting their events through the application, users have their events processed by a limited set of hashing processors. The result of targeting a specific set of miners for dissemination of an event is that a given user achieves some intentionality or agency into which events appear in the same blocks on the blockchain as with their events and where their miners are located.

In some embodiments, users further choose which miners within those executing the custom mempool protocol process and confirm their event. For example, a user inputs parameters for an event to indicate a set of hashing processors that is to process the event. In some cases, the parameters include those able to claim a bounty event based on inclusion in a P2SH instruction. The user thus achieves intentionality into which miners may benefit from events they generate.

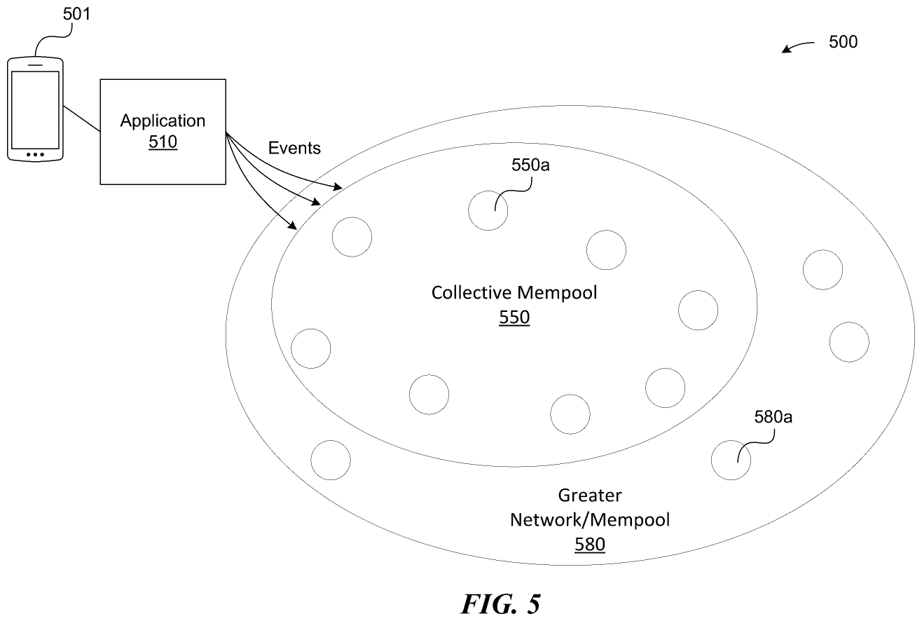

FIG. 5 is a diagrammatic representation of a system 500 with a collective mempool 550 for processing events transmitted by an application. System 500 includes a user device 501 running an application 510, that transmits events to collective mempool 550 which is part of a greater network/mempool 580. Collective mempool 550 is a mempool of a set of hashing processors 550a executing the custom mempool protocol. Greater network/mempool 580 is the mempool of hashing processors of the greater blockchain network (e.g., the Bitcoin or Ethereum network), including those executing the public blockchain protocol but not the custom mempool protocol. Hashing processors are associated with nodes that group together to form pools as described herein. Nodes associated with collective mempool 550 and are executing the custom mempool protocol are also known as filter nodes as described herein. Depicted in the figure, hashing processors 550a is part of a pool of hashing processors corresponding to collective mempool 550 and hashing processors 580a is part of a pool of hashing processors corresponding to the greater network/mempool 580. Each node has its own mempool and holds a full copy of the blockchain.

The depiction in FIG. 5 is for exemplary purposes only and is not intended to be limiting. For example, system 500 includes a plurality of user devices running application 510, each transmitting events or other information to collective mempool 550. Further, collective mempool 550 and greater network/mempool 580 includes a different number of nodes than depicted in FIG. 5. Characteristics described with respect to hashing processors 550a apply to other hashing processors associated with collective mempool 550 and that are executing the custom mempool protocol. Characteristics described herein with respect to hashing processors 580a apply to other hashing processors that are part of the greater network/mempool 580 and that are executing the public blockchain protocol.

User device 501 is a device operated by a user and that runs application 510. User device 501 communicates information to and from collective mempool 550 over a suitable network interface. Examples of user device 501 include a mobile phone, tablet device, personal computer, or the like.

Application 510 is software that enables processing of events by a custom node executing the custom mempool protocol. Application 510 runs on user device 501 and communicates information over an API developed for off-chain events. Application 510 receives user input from user device 501 and transmits events or other information to collective mempool 550. Application 510 receives parameters for events from a user and transmit such events to collective mempool 550. In some embodiments, application 510 selects a set of hashing processors based on the received parameters. In some cases, the received parameters include geographical location information, such that selecting the set of hashing processors involves identifying and limiting the set of hashing processors that process the event to the hashing processors executing the custom mempool protocol and physically located at a location consistent with the geographical location information. Prior to transmitting events to collective mempool 550, application 510 digitally signs the events by a cryptographic private key of user 501 according to the public blockchain protocol.

Collective mempool 550 is a mempool of a set of hashing processors executing the custom mempool protocol. Collective mempool 550 includes a collection of events awaiting verifications and confirmation by the set of hashing processors.

The set of hashing processors associated with collective mempool 550 executes a custom mempool protocol that is independent of the public blockchain protocol. The custom mempool protocol differs from the public blockchain protocol. For example, the set of hashing processors executing the custom mempool protocol will propagate zero-fee transactions and will attempt to mine those transactions along with bounty transactions into the same block.

Embodiments described herein provide multiple benefits. One benefit is that a given user achieves intentionality or agency into which miners may benefit from mining their events. Another benefit is that events processed under the custom mempool protocol are still compatible with the blockchain under the public blockchain protocol. For example, events processed under the custom mempool protocol are hashed into blocks, which are then be broadcast for appending to the blockchain data structure according to the public blockchain protocol. Thus, no changes have to be made to the existing vanilla blockchain protocol.

Greater network/mempool 580 is the mempool of hashing processors of the greater blockchain network. The greater blockchain network includes hashing processors that execute the vanilla blockchain protocol, like those of hashing processors 580a, as well as hashing processors that execute the custom mempool protocol, like those of hashing processors 550a. While not explicitly shown in FIG. 5, it is understood that there is a suitable network interface that enables nodes to communicate information to each other. As described above, nodes with hashing processors executing the custom mempool protocol choose to propagate information to other mempools that vanilla nodes will not.

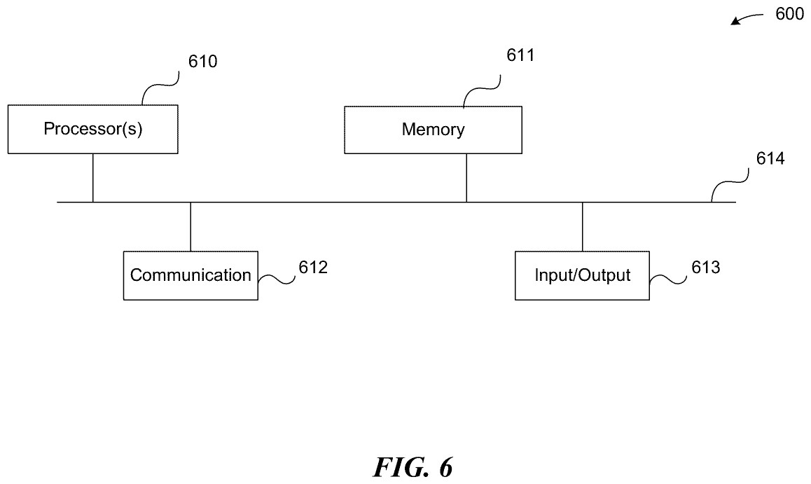

FIG. 6 is a high-level block diagram showing an example of a processing device 600 that can represent a system to run any of the methods/algorithms described above. A processing device used to “mine” cryptographic objects is often evaluated based on a hash rate and an electrical power efficiency. A system may include two or more processing devices such as represented in FIG. 6, which may be coupled to each other via a network or multiple networks. A network can be referred to as a communication network.

In the illustrated embodiment, the processing device 600 includes one or more processors 610, memory 611, a communication device 612, and one or more input/output (I/O) devices 613, all coupled to each other through an interconnect 614. The interconnect 614 may be or include one or more conductive traces, buses, point-to-point connections, controllers, scanners, adapters and/or other conventional connection devices. Each processor 610 may be or include, for example, one or more general-purpose programmable microprocessors or microprocessor cores, microcontrollers, application specific integrated circuits (ASICs), programmable gate arrays, or the like, or a combination of such devices. The processor(s) 610 control the overall operation of the processing device 600. Memory 611 may be or include one or more physical storage devices, which may be in the form of random-access memory (RAM), read-only memory (ROM) (which may be erasable and programmable), flash memory, miniature hard disk drive, or other suitable type of storage device, or a combination of such devices. Memory 611 may store data and instructions that configure the processor(s) 610 to execute operations in accordance with the techniques described above. The communication device 612 may be or include, for example, an Ethernet adapter, cable modem, Wi-Fi adapter, cellular transceiver, Bluetooth transceiver, or the like, or a combination thereof. Depending on the specific nature and purpose of the processing device 600, the I/O devices 613 can include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Physical and functional components (e.g., devices, engines, modules, and data repositories, etc.) associated with processing device 600 can be implemented as circuitry, firmware, software, other executable instructions, or any combination thereof. For example, the functional components can be implemented in the form of special-purpose circuitry, in the form of one or more appropriately programmed processors, a single board chip, a field programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip (e.g., software, software libraries, application program interfaces, etc.). The tangible storage memory can be computer readable data storage. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Note that any and all of the embodiments described above can be combined with each other, except to the extent that it may be stated otherwise above or to the extent that any such embodiments might be mutually exclusive in function and/or structure. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

1. A method of blockchain mining protocol, comprising:
receiving by a transaction intake application, a first set of transaction data;
generating a paired set of processable cryptographic events based on the first set of transaction data, wherein a first paired event includes transacting parties and amounts and a second paired event includes reference to the first paired event and an allow list of miners; and
transmitting the paired set of processable cryptographic events to a mining node mempool of a distributed cryptographic network of mining nodes, wherein the mining nodes are configured to process cryptographic events and append processed cryptographic events as blocks on a blockchain.

2. The method of claim 1, further comprising:
receiving, by a first mining node of the distributed cryptographic network of mining nodes, the paired set of processable cryptographic events including the first paired event and the second paired event; and
propagating the paired set of processable cryptographic events to a mempool of a second mining node of the distributed cryptographic network of mining nodes.

3. The method of claim 2, wherein the first paired event does not include a miner associated transaction fee and the first mining node is executing a custom blockchain protocol that causes the first mining node to propagate cryptographic events without transaction fees rather than discard.

4. The method of claim 2, wherein the first paired event includes an inconsequential miner associated transaction fee.

5. The method of claim 1, further comprising:
in response to processing of the second paired event onto the blockchain, determining whether a given miner who has processed the first paired event onto the blockchain is on the allow list of miners of the second paired event; and
in response to said determination that the given miner is on the allow list of miners, awarding a transaction fee to the given miner via the blockchain.

6. The method of claim 1, wherein the first paired event includes an unspent transaction output that is configured to transfer to a miner that processes the first paired event onto the blockchain upon satisfaction of a predetermined condition associated with the second paired event.

7. The method of claim 6, wherein the predetermined condition is that the miner that processes the first paired event onto the blockchain is identified by the allow list of miners of the second paired event.

8. The method of claim 6, wherein the unspent transaction output is governed by a P2SH pub key address and redeem script associated with the allow list of miners.

9. A method of blockchain mining protocol, comprising:
receiving, by a first mining node, a paired set of processable cryptographic events including a first paired event and a second paired event, the paired set of processable cryptographic events based on a first set of transaction data, wherein the first paired event includes transacting parties and amounts, and the second paired event includes reference to the first paired event and an allow list of miners; and
propagating the paired set of processable cryptographic events to a mempool of a second mining node of a distributed cryptographic network of mining nodes including the first mining node, wherein mining nodes are configured to process cryptographic events and append processed cryptographic events as blocks on a blockchain.

10. The method of claim 9, further comprising:
processing, the first mining node, the first paired event into a block on the blockchain.

11. The method of claim 10, wherein the first paired event includes an unspent transaction output that is configured to transfer to the first mining node upon satisfaction of a predetermined condition associated with the second paired event.

12. The method of claim 11, wherein the predetermined condition is that the first mining node has processed the first paired event onto the blockchain and is identified by the allow list of miners of the second paired event.

13. The method of claim 9, wherein the first paired event does not include a miner associated transaction fee and the first mining node is executing a custom blockchain protocol that causes the first mining node to propagate cryptographic events without transaction fees rather than discard.

14. The method of claim 9, wherein the first mining node is identified on the allow list of miners, and said propagation is to mining nodes, including the second mining node, that are similarly on the allow list of miners.

15. A system of operating a of blockchain mining protocol, comprising:
a transaction intake application server configured to receive a first set of transaction data and subsequently generate a paired set of processable cryptographic events including a first paired event and a second paired event, the paired set of processable cryptographic events based on a first set of transaction data, wherein in response to processing the first paired event by a predetermined miner associated with the second paired event either in an earlier block or the block the second event is processed in, the first paired event is configured to pay out unspent transaction output to the predetermined miner; and
a network interface communicatively coupled to the transaction intake application server configured to propagate the paired set of processable cryptographic events to a mining node mempool of a distributed cryptographic network of mining nodes, wherein the mining nodes are configured to process cryptographic events and append processed cryptographic events as blocks on a blockchain.

16. The system of claim 15, further comprising:
a mempool of a first mining node configured to store cryptographic events prior to processing inclusion onto the blockchain, the mempool governed by a mempool protocol that defines propagation of the cryptographic events to other members of the distributed cryptographic network of mining nodes.

17. The system of claim 16, wherein the mempool protocol is a modified vanilla blockchain protocol that does not discard cryptographic events that do not include a transaction fee portion.

18. The system of claim 16, wherein the mempool protocol is a modified vanilla blockchain protocol that only propagates the paired set of processable cryptographic events to mining nodes on a predetermined allow list.

19. The system of claim 15, wherein the first paired event includes an inconsequential miner associated transaction fee.

20. The system of claim 15, wherein the unspent transaction output is governed by a P2SH pub key address and redeem script associated with the predetermined miner.
